(19) United States
(12) Patent Application Publication
(10) Pub. No.: US 2024/0255541 A1
(43) Pub. Date: Aug. 1, 2024

(54) CHRONOGRAPHY SYSTEM AND METHOD FOR PERFORMING REDUNDANT MEASUREMENT OF PROJECTILE VELOCITY

(71) Applicant: Government of the United States of America, as represented by the Secretary of Commerce, Gaithersburg, MD (US)

(72) Inventors: Dwight David Atherly Barry, Jefferson, MD (US); Nicholas George Paulter, Jr., Silver Spring, MD (US)

(21) Appl. No.: 18/426,179

(22) Filed: Jan. 29, 2024

Related U.S. Application Data
(60) Provisional application No. 63/441,475, filed on Jan. 27, 2023.

(51) Int. Cl. G01P 3/68

(52) U.S. Cl. CPC G01P 3/685

(57) ABSTRACT

A chronograph system has with a set of co-located start planes and a set of co-located stop planes spaced from the start planes, thereby minimizing measurement differences.

### RELATED APPLICATIONS

This application claims the benefit of U.S. Provisional Patent Application Ser. No. 63/441,475 (filed Jan. 27, 2023), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to chronographs, and more particularly to a chronograph system and method with collocated start screens and collocated stop screens.

### BACKGROUND

Ballistic chronographs are specialized devices used to measure the velocity of a projectile, such as a bullet or missile. These chronographs play a crucial role in the field of ballistics, providing valuable data for shooters, engineers, and researchers. The primary purpose of a ballistic chronograph is to determine the speed at which a projectile travels.

Ballistic chronographs typically consist of two or more sensors arranged in a linear fashion. These sensors are typically equipped with photodetectors or infrared sensors. When a projectile passes through the sensors, it interrupts the light beams or triggers the sensors in some way. The chronograph measures the time it takes for the projectile to travel between the sensors. Using the known distance between the sensors, the chronograph calculates the velocity of the projectile using the formula: Velocity=Distance/Time.

There are many types of chronographs, including: light screens, break screens, or laser break beams combined with appropriate timers; radar systems; or imaging systems, such as flash x-ray imaging or high-speed optical photography. Historically, ballistic chronographs used photographic plates or sheets to capture images of the projectile at different points along its path. The time intervals between these images allowed for the calculation of velocity. While effective, this method has largely been replaced by electronic sensors. Modern ballistic chronographs often use light screens equipped with photodetectors. These screens are positioned a known distance apart, and the interruption of light between them triggers the chronograph. The velocity is then calculated based on the time it takes for the projectile to pass through. Some advanced ballistic chronographs use radar technology to measure projectile velocity. These chronographs emit radar waves, and the Doppler shift in the reflected waves is analyzed to determine the speed of the projectile. Radar chronographs are particularly useful for measuring velocities at longer distances. However, because of the radar cross-section of some projectiles, there is a limit to the distance at which radar will be useful.

Measuring the velocity of the bullets that impact body armor and the mass of those bullets are the two factors that are used in evaluating the ballistic performance of body armor worn by law enforcement and military personnel. Particular bullet threats (caliber, mass, and velocity) have been previously defined by the National Institute of Justice (NIJ) [NIJ-0101.06] for assessing ballistic-resistance performance of law enforcement body armor and it is these threats that are used to qualify armor in the NIJ body armor program. Laboratories that test body armor must be able to accurately estimate the bullet velocity during ballistic tests.

The current NIJ document that defines threats is the NIJ Specification for NIJ Ballistic Protection Levels and Associated Test Threats NIJ Standard 0123.00, published October of 2023. Per the NIJ-0101.07, “Second, the ballistic test threats are no longer listed in NIJ Standard 0101.07 as in past revisions of the standard. These have been moved into Specification for NIJ Ballistic Protection Levels Standards and Associated Test Threats, NIJ Standard 0123.00, which is a new standalone document that defines ballistic threats identified by U.S. law enforcement as representative of current prevalent threats in the United States.”

The most common method of measuring bullet velocity in commercial laboratories is a system of commercial light screens and chronographs. Two independent sets of instrumentation, as required by test standards, are typically used. Each set includes a chronograph, or other timing device, and two light screens. When a projectile is fired, the timing device will measure the time interval between the two timing-event signals, one from the first, or start, light screen and one from the second, or stop, light screen. This time interval is used to compute the projectile velocity. Since the projectile timing is measured at only two planes, defined by the light screens, the estimated velocity is the average velocity during the interval that the projectile is traveling between the two light screens, which is approximately the velocity at the center of the projectile's path between the light screens. For the bullets used to test civilian law enforcement body armor, the decrease in velocity between the light screens is typically an order of magnitude less than the allowable tolerance in velocity.

### SUMMARY OF INVENTION

A chronograph system and method is described that includes a new arrangement of light screen pairs in a redundant ballistic chronograph. This arrangement satisfies current ASTM and National Institute of Justice requirements for measuring the ballistic performance of body armor. Although the method may require dismantling the commercially available light screens and installing them on custom-made mounting frames, the overall arrangement is simpler to arrange and to obtain separation uncertainties than the conventional design that uses separate mounting frames.

Exemplary chronography systems include multiply-redundant detector arrays independently arranged at an entrance (start) plane and an exit (stop) plane. An exemplary chronography system has a novel configuration with two or more chronographs that overlap, that is, the entrance planes of all the chronographs are coplanar and the exit planes of all the chronographs are coplanar but separated from each other along a trajectory of a projective along the chronography system. Exemplary chronography systems significantly reduce measurement uncertainty associated with the distance measurement in computing projectile speed.

According to one aspect of the invention, a chronograph has a projectile trajectory axis and includes a first source and detector pair defining a first start plane orthogonal to the projectile trajectory axis and a second source and detector pair defining a second start plane orthogonal to the projectile trajectory axis, wherein the start planes are coincident or approximately coincident, and wherein the first source and detector pair are rotated with respect to the second source and detector pair about the projectile trajectory axis; and a third source and detector pair defining a stop plane orthogonal to the projectile trajectory axis and a fourth source and detector pair defining a second stop plane orthogonal to the projectile trajectory axis, wherein the stop planes are coincident or approximately coincident, and wherein the third source and detector pair are rotated with respect to the fourth source and detector pair about the projectile trajectory axis. The start planes are spaced longitudinally along the projectile trajectory axis from the stop planes.

Optionally, the second source and detector pair are rotated about the projectile trajectory axis approximately 90° with respect to the first source and detector pair.

Optionally, the fourth source and detector pair are rotated about the projectile trajectory axis approximately 90° with respect to the third source and detector pair.

Optionally, the chronograph includes at least one additional source and detector defining at least one additional respective start plane orthogonal to the projectile trajectory axis and coincident or approximately coincident with the first and second start planes; and at least one additional source and detector defining at least one additional respective stop plane orthogonal to the projectile trajectory axis and coincident or approximately coincident with the first and second stop planes.

The foregoing and other features of the invention are hereinafter described in greater detail with reference to the accompanying drawings.

### BRIEF DESCRIPTION OF THE DRAWINGS

FIG. 1 shows a schematic representation of a conventional chronograph with light screen pairs.

FIG. 2 shows a schematic representation of an exemplary chronograph with collocated start screen and collocated stop screens.

FIG. 3 shows an exemplary chronograph in simplified form with collocated screens rotated about the trajectory axis from each other.

FIG. 4 shows recorded differences from 3653 shots vs. estimated velocity.

FIG. 5 shows frequency of occurrence of the velocity differences in the historic test data (see FIG. 4). Not shown in the above are the results from the 22 shots in the historic test data that had differences greater than 6 m/s.

FIG. 6 show an exemplary chronography system having four chronographs, wherein a chronograph includes one start plane and one stop plane. In this demonstrated embodiment, a start plane can be paired with either stop plane for 16 possible pairings, from which a velocity of the projectile, e.g., a bullet, can be determined.

### DETAILED DESCRIPTION

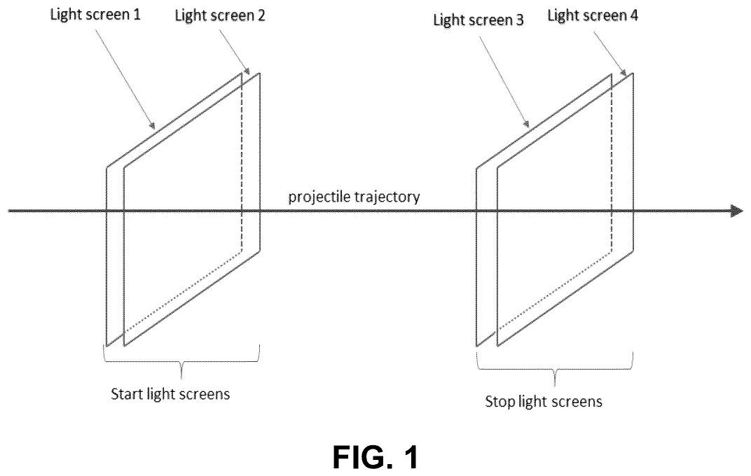

To meet the standard requirements [NIJ-0101.07, ASTM E3062-20] for two independent sets of instrumentation, two chronographs and four light screens (two pairs) are necessary. Since the light screen frames have a finite width, when commercial light screens are used in their normal configuration, there must be either an offset between the two pairs or a different spacing between the pairs, as shown diagrammatically in FIG. 1. The approach of each pair being staggered, that is, having the same spacing with a displacement offset between the pairs, as described in Table 1, was often used prior to the current NIJ standard [NIJ-0101.07], but this approach resulted in differences in the estimated projectile velocities from the two chronographs, due to the measurement locations being different distances from the test article. The approach of each pair having different spacings, with the second pair nested between the first pair, is used to meet the current standard requirements [NIJ-0101.07, ASTM E3062-20]. This second approach reduces the differences in the estimated projectile velocities between the two chronographs but results in each measurement having a different uncertainty. In both approaches, laboratories generally mount both start screens to a common support, and similarly both stop screens are mounted to a different common support, such that any deflection or repositioning of the support will influence the position of both screens.

TABLE 1
Light screens associated with chronographs for different
dual-chronograph arrangements (see FIG. 1).

| | | |
|---|---|---|
| Staggered configuration | Chronograph1 | Light screen 1, light |
| | | screen 3 |
| | Chronograph 2 | Light screen 2, light |
| | | screen 4 |
| Nested configuration | Chronograph1 | Light screen 1, light |
| | | screen 4 |
| | Chronograph 2 | Light screen 2, light |
| | | screen 3 |

However, new exemplary approaches include, modifying a set of commercial light screens such that two or more screens may be co-located. This revised configuration allows all pairs of screens to have the same spacing and measurement uncertainty, while simplifying the arrangement of the instrumentation in the laboratory.

The past versions of the NIJ standard for assessing the performance of ballistic-resistant body armor [NIJ-0101.03, NIJ-0101.04], the current version [NIJ-0101.06], and the ASTM specification for ballistic test ranges [ASTM E3062-20] all require two independent velocity measurement systems to estimate the speeds of the test projectiles. The newest version of the NIJ body armor standard (NIJ-0101.07), was published in October 2023. These standards allow for velocity measurement systems using a variety of different technologies, such as: light screens, break screens, or laser break beams combined with appropriate timers; radar systems; or imaging systems, such as flash x-ray imaging or high-speed optical photography. For a variety of reasons, including ease of installation, flexibility in use, and relatively low cost, the most commonly used technology is commercial light screens combined with digital chronographs or frequency counter-timers. Waveform recorders may also be used to measure the time of flight; however, these are not commonly used in commercial ballistic testing laboratories.

The current tolerance requirement for bullet velocity in NIJ-0101.07 refers to the ASTM E3062, which states in Clause 8.1.4, “The projectile velocity should be determined using at least two electronically independent sets of instrumentation.” and in Clause 8.1.4.1, “For each projectile firing, the two independent sets of instrumentation shall provide individual velocity measurements within 3 m/s [10 ft/s] of each other . . . ”

The chronograph, or timer, itself only provides a time interval measurement for the calculation of velocity. The chronograph relies on signals from two independent light screens, or other detectors, which will produce an electrical pulse or change the state of a binary signal at the instant that the test projectile passes through the detector. Estimation of the projectile velocity requires an accurate measurement of the distance between the two detectors, the travel time of the bullet between the light screens, and an estimation of the measurement uncertainties associated with the distance and time measurements.

Light screens basically provide a sheet of light through which the projectile passes. The light may be provided by a single linear incandescent bulb, an array of lenses that focuses the ambient light, or a linear array of light-emitting diodes (LEDs). Screens that use visible light tend to be easily triggered by reflected light or by changes in the ambient lighting, so laboratory quality commercial light screens generally use an array of infrared LEDs, which are mounted on one side of the light screen. On the opposite side of the light screen is mounted a linear array of diode light detectors. When the projectile passes through the light screen, it blocks some of the light to one or more detectors, which triggers the generation of an electrical pulse that can be detected by a chronograph or other device.

As described above, four light screens (arranged in two pairs) are necessary to meet standard requirements for a minimum of two independent sets of instrumentation. Since the width of the most commonly used commercial light screens is approximately 7 cm, the distance between the sensors for the inner pair of light screens will be at least 14 cm less than the distance for the outer pair. This results in the velocity measurement uncertainty being greater for the inner pair of light screens for conventional light-screen configurations.

Since the estimation of the projectile velocity is an indirect measurement, it is necessary to consider the uncertainties from each of the measurements that can be made directly, and to use the law of propagation of uncertainty (see [Taylor1994]) to calculate the combined standard uncertainty. The relationship between the estimated velocity and the two measured quantities is defined as:

$$v = \frac{d}{{t}_{d}} , \qquad ( 1 )$$

with v representing the estimated projectile velocity, d representing the estimated distance, or length, between the detection points on the start and stop screens, and t_{d} is the delay between stop and start timing events that represent the estimated time of flight for the projectile between the two screens. Using the law of propagation of uncertainty, and assuming that the measurements of the length and time are completely independent, which will lead to the estimated covariance being zero, the uncertainty of the velocity estimate has been shown to be:

$${u}_{c} ( v ) = v \sqrt{\frac{{u}_{d}^{2}}{{d}^{2}} + \frac{{u}_{{t}_{d}}^{2}}{{t}_{d}^{2}}} \qquad ( 2 )$$

Here u_{c}(v) represents the combined standard uncertainty of the velocity estimate, and u_{d} and uₜ_{_{d}} represent the estimated uncertainties of the measurements of d and t_{d}. The t_{d} is computed using

$${t}_{d} = {t}_{stop} - {t}_{start} \qquad ( 3 )$$

where tₛₜₒₚ is the reference instant for the stop event (the pulse from the stop light screen) and tₛₜₐᵣₜ is the reference instant for the start event (the pulse from the start light screen). The reference instants are instants that the pulse exceeds a reference level of the pulse, such as a level corresponding to 50% of the pulse amplitude. Detailed explanations of the measurement uncertainty of these components are known in the art. Factors contributing to the measurement uncertainty in the length estimation include errors in the length measurement, misalignment of the screens from parallel to each other, misalignment of screens from perpendicular to the projectile's line of flight, projectile yaw, and changes in the screen spacing due to temperature fluctuations. When these individual components are not correlated, the root-sum-of-squares method may be used to combine them into a single uncertainty value.

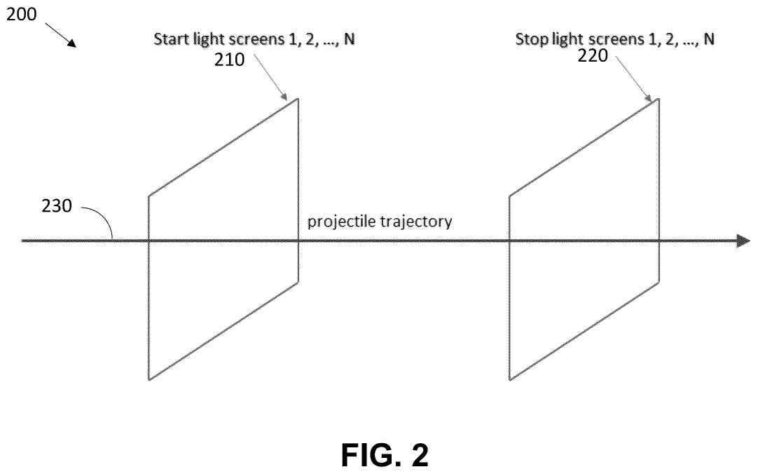

The arrangement for the light screens in exemplary embodiments, although illustrated here for only two light-screen pairs, may include more than two light screens at either the start or stop screen locations (as shown diagrammatically in FIG. 2). This arrangement satisfies the requirements of the NIJ-0101.07 (through ASTM E3062) for the placement of the light screens such that both pairs are centered at the same location along the projectile trajectory while still allowing both pairs to have the same separation between light screens.

Exemplary chronography systems associate multiple detector arrays in both the entrance (start) plane and exit (stop) plane of the chronography system. The configuration of detector arrays provides multiple detector arrays disposed on either or both the start and stop planes and with nominally equal spacing between the start and stop planes. This configuration provides redundant measurements of projectile velocity (speed) and decreases measurement uncertainty of speed. It solves the technical problem of redundant measurements having nominally the same separation between the paired start and stop planes of a chronograph along the projectile trajectory.

As described herein, a chronography system 200 includes a multiply-redundant chronograph with a new configuration of multiple detector arrays in the entrance and exit planes for redundant projectile velocity (speed) measurements. The velocity (speed), v, of the projectile is computed from the separation, dₛ, between the entrance and exit planes and the transit time, tᵣ, of the projectile between the entrance and exit planes. An entrance or exit plane comprises a detector array and typically an external illuminator separated sufficiently to allow passage of a projectile without interference of that projectile by the detector array or its illuminator. The entrance plane provides the start instant for computing tᵣ. The exit plane provides the stop instant for computing tᵣ. The new configuration comprises two or more detector arrays for the entrance plane and two or more detector arrays for the exit plane. This configuration gives N values of dₛ and tᵣ and, consequently for v, where Nis the number of chronographs. The illuminator may be achieved using a linear array of discrete diode light sources, a continuous/extended light source, etc. The length of the illuminator extends the nominal length (either L₁ or L₂) of the aperture. The detector array is a linear arrangement of discrete optical detectors, and its length extends the nominal length (either L₂ or L₁) of the aperture. The illuminator and detector array are nominally in the same plane for a given start plane or a given stop plane.

The chronography system 200 can be interposed between a source of a projectile, e.g., a muzzle of a firearm and an intended target of the projectile, e.g., a bullet-proof body armor. Additional applications of chronography system 200 are envisioned.

The chronography system 200 includes multiple detector arrays 210, 220 that are associated independently with the entrance and exit planes, wherein a separation between entrance and exit planes along the projectile trajectory axis 230 can nominally be equal. FIG. 2 shows an arrangement of two or more chronographs of chronography system 200.

In an embodiment, chronography system 200 includes two redundant chronographs. Some embodiments can include as many chronographs as physically compatible with acquiring projectile speed determined by the separation between detector arrays in the entrance and exit planes.

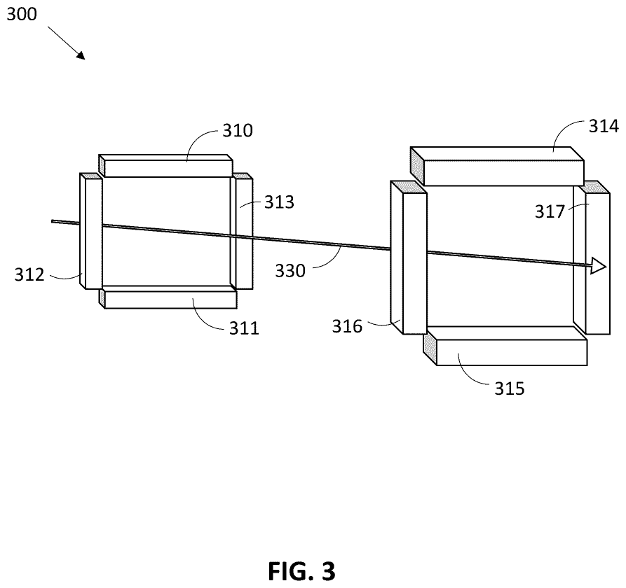

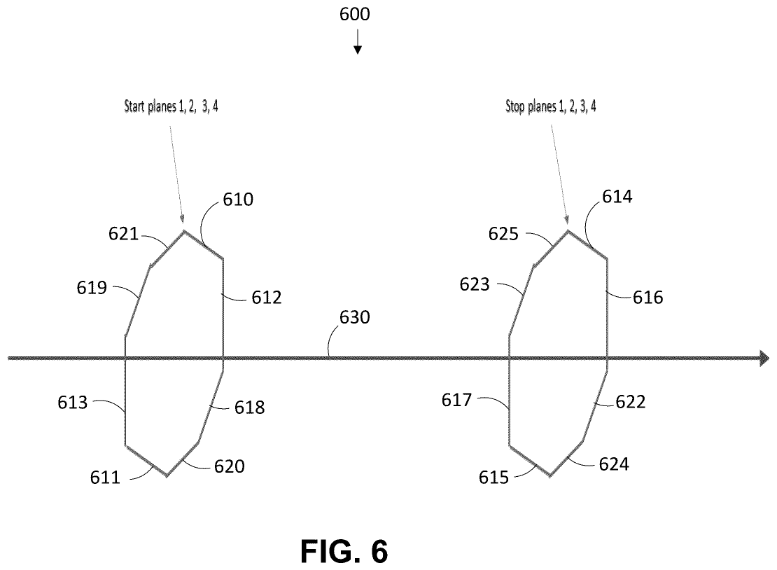

In an embodiment, chronography system 200 including a plurality, e.g., two or more, detector arrays for the entrance plane and a plurality (e.g., two or more) detector arrays for the exit plane. The number of possible pairings of entrance planes and exit planes can be N², where Nis the number of entrance planes and the number of exit planes. In FIG. 3, N=2, and in FIG. 6, N=4. N can have an upper limit determined from optical interference between adjacent illuminator/detector pairs in a given plane. The entrance plane detectors and sources are co-planar. The exit plane detectors and sources are co-planar. The entrance plane and the exit plane are separated along the trajectory of the projectile.

In an embodiment, chronography system 200 includes an external illuminator.

In an embodiment, a performing redundant measurement of projectile velocity includes interposing chronography system 200 between the source of a projectile and the target of the projectile. The process can include communicating the projectile through the entrance and exit planes of chronography system 200.

Chronography system 200 can be made of various elements and components that are fabricated or assembled from commercial suppliers. Elements of chronography system 200 can be various sizes. Elements of chronography system 200 can be made of a material that is physically or chemically resilient in an environment in which chronography system 200 is disposed. Exemplary materials include a metal, ceramic, thermoplastic, glass, semiconductor, and the like. The elements of chronography system 200 can be made of the same or different material and can be monolithic in a single physical body or can be separate members that are physically joined.

Chronography system 200 can be made in various ways. It should be appreciated that chronography system 200 includes a number of optical, electrical, or mechanical components, wherein such components can be interconnected and placed in communication (e.g., optical communication, electrical communication, mechanical communication, and the like) by physical, chemical, optical, or free-space interconnects. The components can be disposed on mounts that can be disposed on a bulkhead for alignment or physical compartmentalization. As a result, chronography system 200 can be disposed in a terrestrial environment or space environment. Elements of chronography system 200 can be formed from silicon, silicon nitride, and the like although other suitable materials, such ceramic, glass, or metal can be used. According to an embodiment, the elements of chronography system 200 are formed using 3D printing although the elements of chronography system 200 can be formed using other methods, such as injection molding or machining a stock material such as block of material that is subjected to removal of material such as by cutting, laser oblation, and the like. Accordingly, chronography system 200 can be made by additive or subtractive manufacturing.

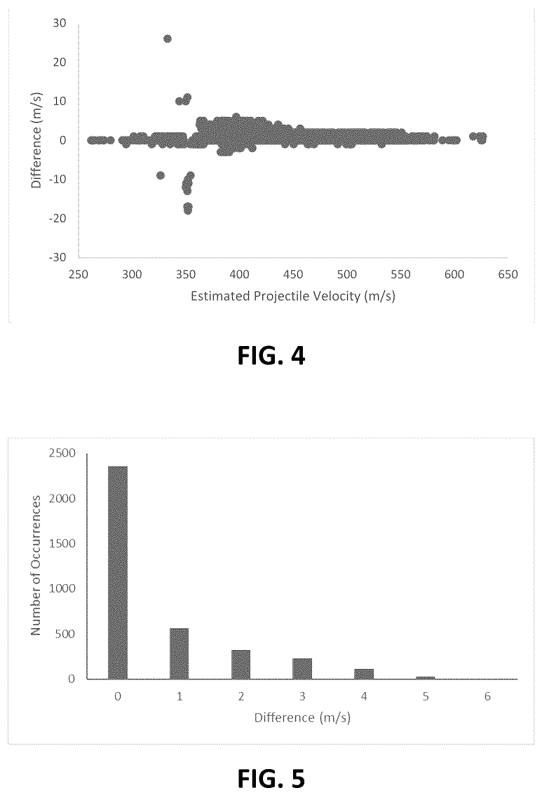

Analysis of historical data using a conventional staggered screen configuration showed that out of 3653 shots, 1292 (35%) had absolute differences of 1.0 m/s or more between the two velocity measurements. This data, plotted in FIG. 4, included shots with three different calibers of bullet (9 mm, 357 magnum, and 44 magnum), and with estimated velocities from 262 m/s to 627 m/s. The frequency distribution of the differences in the measurements is shown in FIG. 5. The standard deviation of these differences was 1.61 m/s, which can be considered as the combined instrumental uncertainty for two separate instruments.

For a normally distributed response, with the uncertainty of each chronograph-light screen system being independent, the combined instrument uncertainty is the square root of the sum of the squares of the two individual instrument uncertainties. Since both sets of instrumentation use similar components, the uncertainties associated with each set should be approximately equal; therefore, the individual instrumental certainty can be estimated as the combined instrumental uncertainty divided by the square root of 2. This results in a measurement uncertainty for this historical data for a single chronograph of approximately of 1.14 m/s, which is greater than the 1.0 m/s allowed by NIJ-0101.06. However, recent observations have demonstrated a velocity difference of nominally 3 m/s to 4 m/s, which is greater than the historical record presented herein.

Consequently, exemplary arrangements are based on the components, specifically, the light sources and the linear detector arrays, of commercially available light screens. These components may be mounted to provide two start light screens at one common plane and two stop light screens at another common plane, as shown in FIG. 3). In particular, chronograph 300 is shown having a first source 310 and detector 311 pair defining a first start plane orthogonal to the projectile trajectory axis 330 and a second source 312 and detector 313 pair in the same (or approximately the same) start plane and rotated with respect to the first source and detector pair 310, 311 about the projectile trajectory axis 330. Although the rotation amount may be any amount that allows both light screens to be placed in the same (or approximately the same) plane, the illustrated exemplary embodiments are rotated +/−90° with respect to each other. Spaced longitudinally along the projectile trajectory axis 330 from the start source and detector pairs are third and fourth source 314, 316 and detector 315, 317 pairs placed in the same (or approximately the same) plane as each other and rotated with respect to each other. Again, any appropriate rotation is allowable, but preferable exemplary embodiments are rotated +/−90°. In some embodiments, the orientation of matched start and stop light screens about the projectile axis 330 are aligned to each other.

The mounting structure (not shown) for the light sources and detector arrays serve three functions. One function is the obvious structural support of the light sources and detector arrays. Different materials may be used for the mounting structure, including wood-based products and non-wood-based products. Wood products, and not metal or plastic, may be selected to help minimize the propagation of pressure waves between the start and stop planes and, thus, reduce the probability of false triggering by the pressure waves. The mounting structure also provides a well-defined reference surface for measuring the separation between the detector arrays of the start and stop planes, and this facilitates the adjustment of the parallelism between the start and stop planes. The mounting structure, as designed here, also acts as a blast shield. The necessity of a blast shield became obvious when velocities of sub-sonic projectiles were erroneously measured to have nominally sonic velocities. These aberrant velocities are caused by ejecta from the muzzle blast that occludes the light to the detector arrays. This problem occurs for sub-sonic projectiles in which the ejecta travels faster than the projectile. Although a blast shield is placed near the muzzle, aberrant sonic velocities of sub-sonic particles were still observed although not as often as without this blast shield. The secondary blast shield incorporated into the mounting structure effectively eliminated the remaining aberrant sonic velocity measurements.

FIG. 6 shows an example chronograph 600 in which first and second source 610, 612 and detector 611, 613 are joined by fifth and sixth source 618, 620 and detector 619, 621 pairs spaced longitudinally along the projectile trajectory axis 630 from third and fourth source 614, 616 and detector 615, 617 pairs that are, themselves, joined with seventh and eighth source 622, 624 and detector 623, 625 pairs.

The described exemplary arrangements of light screen pairs described herein results in an average combined instrumental uncertainty for two chronographs for all shots of approximately 0.96 m/s (or less), or about 0.69 m/s for one chronograph, which is less than the limit of 1 m/s specified in NIJ-0101-07. Moreover, the measurement uncertainty in the separation between light screens is easier to compute for the exemplary arrangements of light screen pairs than it is for the staggered or nested light-screen configurations. Lastly, the new configuration allows the start and stop light screens of the two chronographs to have nominally the same separation (within the combined measurement uncertainty of that separation) and to have nominally the same center.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A chronograph having a projectile trajectory axis comprising:
a first source and detector pair defining a first start plane orthogonal to the projectile trajectory axis and a second source and detector pair defining a second start plane orthogonal to the projectile trajectory axis, wherein the start planes are coincident or approximately coincident, and wherein the first source and detector pair are rotated with respect to the second source and detector pair about the projectile trajectory axis; and
a third source and detector pair defining a stop plane orthogonal to the projectile trajectory axis and a fourth source and detector pair defining a second stop plane orthogonal to the projectile trajectory axis, wherein the stop planes are coincident or approximately coincident, and wherein the third source and detector pair are rotated with respect to the fourth source and detector pair about the projectile trajectory axis; and
wherein the start planes are spaced longitudinally along the projectile trajectory axis from the stop planes.

2. The chronograph of claim 1, wherein the second source and detector pair are rotated about the projectile trajectory axis approximately 90° with respect to the first source and detector pair.

3. The chronograph of claim 1, wherein the fourth source and detector pair are rotated about the projectile trajectory axis approximately 90° with respect to the third source and detector pair.

4. The chronograph of claim 1, further comprising:
at least one additional source and detector defining at least one additional respective start plane orthogonal to the projectile trajectory axis and coincident or approximately coincident with the first and second start planes; and
at least one additional source and detector defining at least one additional respective stop plane orthogonal to the projectile trajectory axis and coincident or approximately coincident with the first and second stop planes.
